(19) United States
(12) Patent Application Publication
(10) Pub. No.: US 2008/0235724 A1
(43) Pub. Date: Sep. 25, 2008

(54) Face Annotation In Streaming Video

(75) Inventors: Frank Sassenscheidt, Würselen (DE); Christian Benien, Aachen (DE); Reinhard Kneser, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/088,001

(22) PCT Filed: Sep. 19, 2006
(86) PCT No.: PCT/IB2006/053365

§ 371 Date: Mar. 25, 2008

(30) Foreign Application Priority Data
Sep. 30, 2005 (EP) 05109062.9

(51) Int. Cl. H04N 9/81

(52) U.S. Cl. 725/32

(57) ABSTRACT

The invention relates to a system (5, 15) and a method for detecting and annotating faces on-the-fly in video data. The annotation (29) is performed by modifying the pixel content of the video and is thereby independent of file types, protocols and standards. The invention can also perform real-time face-recognition by comparing detected faces with known faces from storage, so that the annotation can contain personal information (38) relating to the face. The invention can be applied at either end of a transmission channel and is particularly applicable in videoconferences, Internet classrooms, etc.

The present invention relates to streaming video. In particular, the invention relates to detecting and recognising faces in video data.

Often, the quality of streaming video makes it difficult to recognise faces of persons appearing in the video, especially if the image includes several persons so that it is not zoomed in on one person. This is a disadvantage when performing e.g. videoconferences because the viewers cannot determine who is speaking unless they recognise the voice.

WO 04/051981 discloses a video camera arrangement that can detect human faces in video material, extract images of the detected faces and provide these images as metadata to the video. The metadata can be used to quickly establish the content of the video.

It is an object of the invention to provide a system and a method for performing real-time face-detection in streaming video and modifying the streaming video with annotations relating to detected faces.

It is a further object of the invention to provide a system and a method for performing real-time face-recognition of detected faces in streaming video and modifying the streaming video with annotations relating to recognised faces.

In a first aspect, the invention provides a system for real-time face-annotating of streaming video, the system comprising:

a streaming video source;

a face-detection component operable connected to receive streaming video from the streaming video source and being configured to perform a real-time detection of regions holding candidate faces in the streaming video;
an annotator being operable connected to receive:
   the streaming video;
   locations of candidate face regions from the face-detection component;
the annotator being configured to modify pixel content in the streaming video related to at least one candidate face region;
   an output being operable connected to receive the face-annotated streaming video from the annotator.

Streaming is a technology that sends data from one point to another in a continuous mass of data, typically used on the Internet and other networks. Streaming video is a sequence of “moving images” that are sent in compressed form over the network and displayed by the viewer as they arrive. With streaming video, a network user does not have to wait to download a large file before seeing the video or hearing the sound. Instead, the media is sent in a continuous stream and is played as it arrives. The transmitting user needs a video camera and an encoder that compresses the recorded data and prepares it for transmission. The receiving user needs a player, which is a special program that uncompresses and sends video data to the display and audio data to speakers. Major streaming video and streaming media technologies include RealSystem G2 from RealNetwork, Microsoft Windows Media Technologies (including its NetShow Services and Theater Server), and VDO. The program that does the compression and decompression is also referred to as the codec. Typically, the streaming video will be limited to the data rates of the connection (for example, up to 128 Kbps with an ISDN connection), but for very fast connections, the available software and applied protocols sets an upper limit. In the present description, streaming video covers:

Server→Client(s): Continuous transmission of pre-recorded video files, e.g. viewing video on from the www.

Client [symbol] Client: One- or two-way transmissions of live recorded video data between two users, e.g. videoconferences, video chat.

Server/client→Multiple clients: Live broadcast transmissions in which case the video signal is transmitted to multiple receivers (multicast), e.g. Internet news channels, videoconferences with three or more users, internet classrooms.

Also, a video signal is streaming at all times when processing of it takes place real-time or on the fly. For example, the signal in the signal path between a video camera and the output of an encoder, or between a decoder and a display, is also regarded as a streaming video in the present context.

Face-detection is a procedure for finding candidate face regions in an image or a stream of images, meaning regions which holds an image of a human face or resembling features. The candidate face region, also referred to as the face location, is the region in which features resembling a human face has been detected. Preferably, the candidate face region is represented by a frame number and two pixel-coordinates forming diagonal corners in a rectangle around the detected face. For the face-detection to be real-time, the face-detection carries out on-the-fly as the component, typically a computer processor or an ASIC, receives the image or video data. The prior art provides several descriptions of real-time face-detection procedures, and such known procedures may be applied as instructed by the present invention.

Face-detection can be carried out by searching for the face-resembling features in a digital image. As each scene, cut or movement in a video typically lasts many frames, when a face is detected in one image frame, the face is expected to be found in the video for a number of succeeding frames. Also, as image frames in video signals typically changes much faster than persons or cameras move, it is expected that faces detected at a certain location in one image frame can be found at the substantially same location in a number of succeeding frames. For these reasons, it may be advantageous the face detection where carried out only on some selected image frames, e.g. every 10th, 50th or 100th image frame. Alternatively, the frames in which face-detection is performed is selected using other parameters, e.g. one selected frame every time an overall change such as a cut or shift in scene can be detected. Hence, in a preferred embodiment:

the streaming video source is configured to provide un-compressed streaming video comprising image frames; and

the face-detection component is further configured to perform detection only on selected image frames of the streaming video.

In a preferred implementation, the system according to the first aspect can also recognise faces in the video, which are already known to the system. Thereby, the system can annotate the video with information relating to the persons behind the faces. In this implementation, the system further comprises

a storage holding data identifying one or more faces and related annotation information; and

a face-recognition component operable connected to receive candidate face regions from the face-detection component and access the storage, and being configured to perform a real-time identification of candidate faces in the storage,

and herein

the annotator is further operable connected to receive
information that a candidate face has been identified, and
annotation information for any identified candidate faces from either of the face-recognition component or the storage; and

the annotator is further configured to include annotation information in relation to identified candidate faces in the modulation of pixel content in the streaming video.

Face-recognition is a procedure for matching a given image of a face with an image of the face of a known person (or data representing unique features of the face), to determine whether the faces belong to the same human person. In the present invention, the given image of a face is the candidate face region identified by the face-detection procedure. For the face-recognition to be real-time, the face-recognition carries out on-the-fly as the component, typically a computer processor or an ASIC, receives the image or video data. The face-recognition procedure makes use of examples of faces of already known persons. This data is typically stored in a memory or storage accessible for the face-recognition procedure. The real-time processing requires fast access to the stored data, and the storage is preferably of a fast accessible type, such as RAM (Random Access Memory).

When performing the matching, the face-recognition procedure determines a correspondence between certain features of the stored face and the given face. The prior art provides several descriptions of real-time face-recognition procedures, and such known procedures may be applied as instructed by the present invention.

In the present context, the modification or annotation performed by the annotator means an explanatory note, comment, graphic feature, improved resolution, or other marking of the candidate face region that conveys information relating to the face to the viewer of the streaming video. Several examples of annotation will be given in the detailed description of the invention. Accordingly, a face-annotated streaming video is a streaming video, parts of which contains annotation in relation to at least one face appearing in the video.

An identified face may be related to annotation information providing information that can be given as annotation in relation to the face, e.g. the name, title, company, location of the person, preferred modification of the face such as making the face anonymous by putting a black bar in front of the face.

Other annotation information which are not necessarily linked to the identity of the person behind the face include: icons or graphics linked to each face so that they can be differentiated even when changing places, indication of the face belonging to the person currently speaking, modification of faces for the sake of entertainment (e.g. adding glasses or fake hair).

The system according to the first aspect may be located at either end of a streaming video transmission as indicated earlier. Hence, the streaming video source may comprise a digital video camera for recording a digital video and generate the streaming video. Alternatively, the streaming video source may comprise a receiver and a decoder for receiving and decoding a streaming video. Similarly, the output may comprise an encoder and a transmitter for encoding and transmitting the face-annotated streaming video. Alternatively, the output may comprise a display operable connected to receive the face-annotated streaming video from the output terminal and display it to an end user.

In a second aspect, the invention provides a method for making face-annotation of streaming video, such as a method to be carried out by the system according to the first aspect. The method of the second aspect comprises the steps of:

receiving streaming video;

performing a real-time face-detection procedure to detect regions holding candidate faces in the streaming video; and

annotating the streaming video by modifying pixel content in the streaming video related to at least one candidate face region.

The remarks given in relation to the system of the first aspect are generally also applicable to the method of the second aspect. Hence, it may be preferred that the streaming video comprises un-compressed streaming video consisting of image frames, and that the face-detection procedure is performed only on selected image frames of the streaming video.

In order to also perform face-recognition, the method may preferably further comprise the steps of:

providing data identifying one or more faces;

performing a real-time face-recognition procedure to perform a real-time identification of candidate faces in the data; and

including annotation information related to identified candidate faces in the modulation of pixel content in the streaming video.

The basic idea of the invention is to detect faces in video signals on-the-fly and to annotate these by modifying the video signal as such. I.e. the pixel content in the displayed streaming video is changed. This is to be seen in contrast to just attaching or enclosing meta-data with information similar to the annotations. This has the advantages of being independent of any file formats, communication protocols or other standards used in the transmission of the video. Since the annotation is performed on-the-fly, the invention is particularly applicable in live transmissions such as videoconferences, and transmissions from debates, panel discussions etc.

Embodiments of the invention will now be described, by way of example only, with reference to the accompanying drawings, in which:

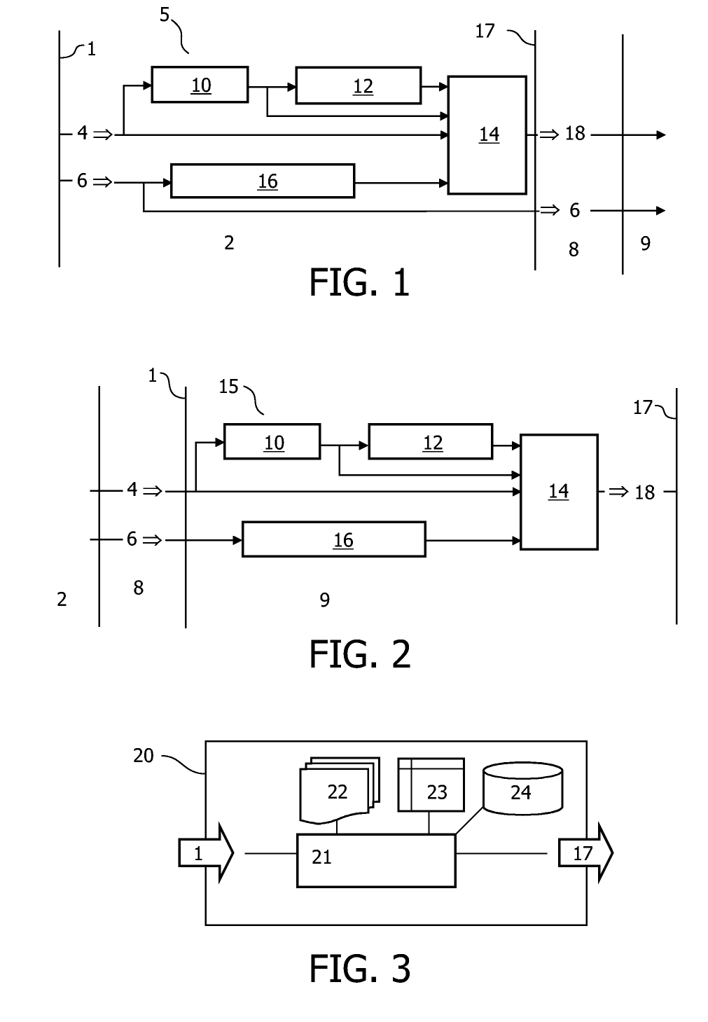

FIG. 1 schematically illustrates a system for real-time face annotating of streaming video situated at the transmitting part.

FIG. 2 schematically illustrates a system for real-time face annotating of streaming video situated at the receiving part.

FIG. 3 is a schematic diagram illustrating a hardware module of an embodiment of a system for real-time face-annotation.

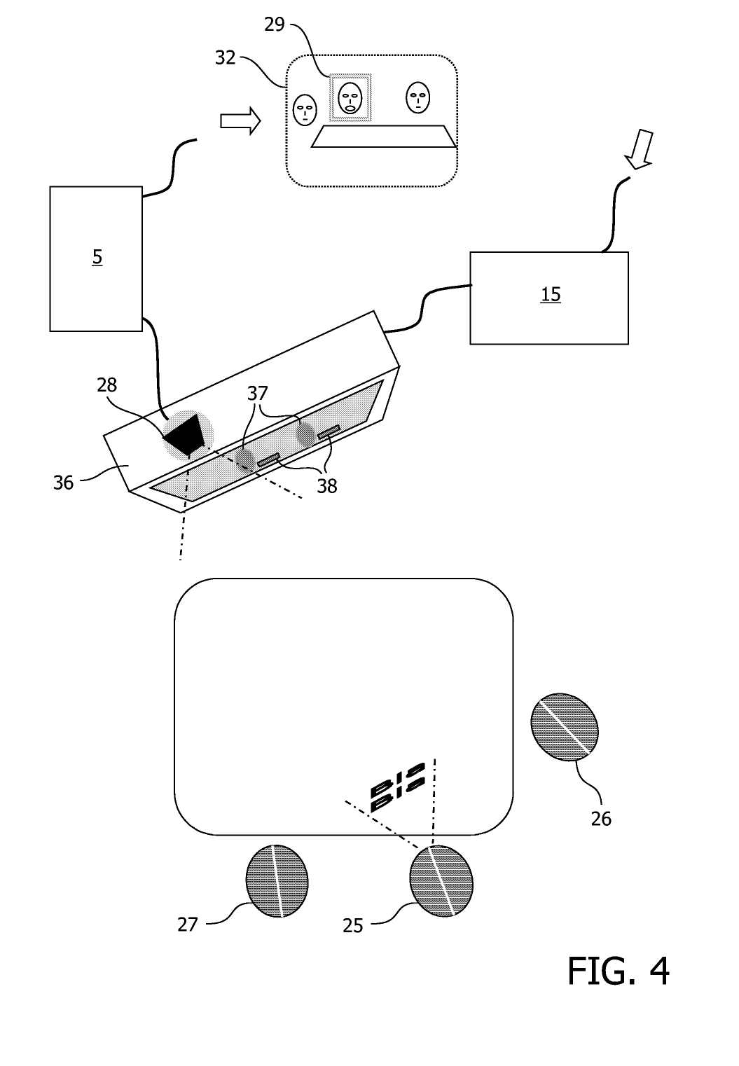

FIG. 4 is a schematic drawing illustrating a videoconference using systems for real-time face-annotation.

FIG. 1 schematically illustrates a how a recorded streaming video signal 4 is face-annotated at the sender 2 before transmittance of the face-annotated signal 18 through a standard transmission channel 8 to a receiver 9. The sender 2 can be one party in a videoconference, and the input 1 can be a digital video camera recording and generating the streaming video signal 4. The input can also simply receive a signal from a memory or from a camera not forming part of the system 5. The transmission channel 8 may be any data transmission line with an applicable format, e.g. a telephone line with an ISDN (Integrated Services Digital Network) connection. In the other end, receiving the face-annotated streaming video, the receiver 9 can be another party in the videoconference.

The system 5 for real-time face-annotation of streaming video receives the signal 4 at input 1 and distributes it to both an annotator 14 and a face-detection component 10. The face-detection component 10 can be a processor executing face-detection algorithms of a face-detection software module. It searches image frames of the signal 4 for regions that resemble human faces and identify any such regions as candidate face regions. The candidate face regions are then made available to the annotator 14 and a face-recognition component 12. The face-detection component 10 can for example create and supply an image consisting of the candidate face region, or it may only provide data indicating the position and size of the candidate face region in the streaming video signal 4.

Detecting faces in images can be performed using existing techniques. Different examples of existing face detection components are known and available, e.g.

webcams performing face detection and face tracking.

Auto Focus cameras with a face-priority or

face detection software which automatically identifies key facial elements, allowing red eye correction, portrait cropping, adjustment of skin tone, etc. in digital image post-processing.

When the annotator 14 receives the signal 4 and a candidate face region, the annotator modifies the signal 4. In the modification, the annotator changes pixels in the image frames, so that the annotation becomes an integrated part of the streaming video signal. The resulting face-annotated streaming video signal 18 is fed to the transmission channel 8 by output 17. When receiver 9 watches the signal 18, the face-annotation will be an inseparable part of the video and appear as originally recorded content. The annotation based solely on candidate face regions (i.e. no face recognition) will typically not be information relating to the identity of the person. Instead, the annotation can for example be to improve the resolution in candidate face regions or graphics indicating the current speaker (each person may be wearing a microphone in which case it is easy to identify the current speaker).

A face-recognition component 12 can compare candidate face regions to face data already available to identify faces that match a candidate face region. The face-recognition component 12 is optional, as the annotator 14 can annotate video signals based only on candidate face regions. A database accessible to the face-recognition component 12 can hold images of faces of known persons or data identifying faces such as skin, hair and eye colour, distance between eyes, ears and eyebrows, height and width of head, etc. If a match is obtained, the face-recognition component 12 notifies the annotator 14 and possibly supplies further annotation information such as a high resolution image of the face, an identity such as name and title of the person, instructions of how to annotate the corresponding region in the streaming video 4, etc. The face-recognition component 12 can be a processor executing face-detection algorithms of a face-detection software module.

Recognition of a face in a candidate face region of the streaming video can be performed using existing techniques. Examples of these techniques are described in the following references:

Beyond Eigenfaces: Probabilistic Matching for Face Recognition Moghaddam B., Wahid W. & Pentland A. International Conference on Automatic Face & Gesture Recognition, Nara, Japan, April 1998.

Probabilistic Visual Learning for Object Representation Moghaddam B. & Pentland A. Pattern Analysis and Machine Intelligence, PAMI-19 (7), pp. 696-710, July 1997

A Bayesian Similarity Measure for Direct Image Matching Moghaddam B., Nastar C. & Pentland A. International Conference on Pattern Recognition, Vienna, Austria, August 1996.

Bayesian Face Recognition Using Deformable Intensity Surfaces Moghaddam B., Nastar C. & Pentland A. IEEE Conf. on Computer Vision & Pattern Recognition, San Francisco, Calif., June 1996.

Active Face Tracking and Pose Estimation in an Interactive Room Darrell T., Moghaddam B. & Pentland A. IEEE Conf. on Computer Vision & Pattern Recognition, San Francisco, Calif., June 1996.

Generalized Image Matching: Statistical Learning of Physically-Based Deformations Nastar C., Moghaddam B. & Pentland A. Fourth European Conference on Computer Vision, Cambridge, UK, April 1996.

Probabilistic Visual Learning for Object Detection Moghaddam B. & Pentland A. International Conference on Computer Vision, Cambridge, Mass., June 1995.

A Subspace Method for Maximum Likelihood Target Detection Moghaddam B. & Pentland A. International Conference on Image Processing, Washington D.C., October 1995.

An Automatic System for Model-Based Coding of Faces Moghaddam B. & Pentland A. IEEE Data Compression Conference, Snowbird, Utah, March 1995.

View-Based and Modular Eigenspaces for Face Recognition Pentland A., Moghaddam B. & Starner T. IEEE Conf. on Computer Vision & Pattern Recognition, Seattle, Wash., July 1994.

FIG. 2 schematically illustrates a how a received streaming video signal 4 is annotated at the receiver 9 before displaying the face-annotated streaming video 18 to the end user. The performance and components of system 15 for real-time face-annotation of streaming video is similar to those of system 5 of FIG. 1. In FIG. 2, however, the system 15 receives signal 4 at input 1 from the sender 2 over transmission channel 8. Input 1 can be a player that decompresses the streaming video signal 4. The sender 2 has generated and transmitted the streaming video signal 4 by any available technology capable of doing so. Also, the face-annotated video signal 18 is not transmitted over a network, instead, output 17 can be a display showing the streaming video to a user. The output 17 can also send the face-annotated video to a memory for storage or to a display not forming part of the system 15.

The systems 5 and 15 described in relation to FIGS. 1 and 2 may also handle a streaming audio signal 6, recorded and played together with the streaming video signals 4 and 18, but not annotated. Each person may have an individual microphone input to the system, so that the current speaker is determined by which microphone picks up the most signal. The audio signal 6 can also be used by a voice recogniser or locator 16 of the systems 5 and 15, which can be used in identifying or locating a currently speaking person in the video.

FIG. 3 illustrates a hardware module 20 comprising various components of the systems 5 and 15 for real-time face annotating of streaming video. The module 20 can e.g. be part of a personal computer, a handheld computer, a mobile phone, a video recorder, videoconference equipment, a television set, a set-top box, a satellite receiver, etc. The module 20 has input 1 capable of generating or receiving video and output 17 capable of transmitting or displaying video corresponding to the type of module, and whether it operates as a system 5 situated at the sender or a system 15 situated at the receiver.

In one embodiment, module 20 holds a bus 21 that handles data flow, a processor 22, e.g. a CPU (central processing unit), internal fast access memory 23, e.g. RAM, and non-volatile memory 24, e.g. magnetic drive. The module 20 can hold and execute software components for face-detection, face-recognition and annotation according to the invention. Similarly, the memories 23 and 24 can hold data corresponding to faces to be recognized as well as related annotation information.

FIG. 4 illustrates a live videoconference between two parties, 25-27 in one end and 37 in another end. Here, persons 25-27 are recorded by digital video camera 28 that sends streaming video to system 5. The system determines candidate face regions in the video corresponding to faces of persons 25-27, and compares them with stored known faces. The system identifies one of them, person 25, as Ms. M. Donaldson, the meeting organiser. The system 5 therefore modifies the resulting streaming video 32 with a frame 29 around the head of Ms. Donaldson. Alternatively, the system can identify a person currently speaking by recognising the face associated to the person of a recognised voice. By aid of a built-in microphone in camera 28, the system 5 can recognise the voice of Ms. Donaldson, associate it with the recognised face and indicate her as the speaker in streaming video 32 by a frame 29. In an alternative embodiment, system 5 improves the resolution in the candidate face region of the identified speaker on behalf of the resolution in the remaining regions, thereby not increasing the required bandwidth.

In the other end of the videoconference, a standard setup records and transmits streaming video of users 37 to users 25-27. By receiving the streaming video with system 15, the incoming standard streaming video can be face-annotated before display to users 25-27. Here, system 15 identifies faces of persons 37 as faces of stored identities, and modulates the signal by adding name and title tags 38 to persons 37.

In another embodiment, the system and method according to the invention is applied at conventions or parliaments such as the European Parliament. Here, hundreds of potential speakers participate, and it may be difficult for a commentator or a subtitler to keep track of the identities. By having photos of all participants on storage, the invention can keep track of persons currently in the camera coverage.

1. A system (5,15) for real-time face-annotating of streaming video, the system comprising:
a streaming video source (1);
a face-detection component (10) operable connected to receive streaming video (4) from the streaming video source and being configured to perform a real-time detection of regions holding candidate faces in the streaming video;
an annotator (14) being operable connected to receive:
the streaming video;
locations of candidate face regions from the face-detection component;
the annotator being configured to modify pixel content in the streaming video related to at least one candidate face region;
an output (17) being operable connected to receive the face-annotated streaming video (18) from the annotator.

2. The system according to claim 1, wherein:
the streaming video source (1) is configured to provide un-compressed streaming video comprising image frames; and
the face-detection component (10) is further configured to perform detection only on selected image frames of the streaming video.

3. The system according to claim 1, further comprising
a storage (23, 24) holding data identifying one or more faces and related annotation information; and
a face-recognition component (12) operable connected to receive candidate face regions from the face-detection component (10) and access the storage, and being configured to perform a real-time identification of candidate faces in the storage,
and wherein
the annotator (14) is further operable connected to receive
information that a candidate face has been identified, and
annotation information for any identified candidate faces from either of the face-recognition component or the storage; and
the annotator is further configured to include annotation information in relation to identified candidate faces in the modulation of pixel content in the streaming video.

4. The system according to claim 1, wherein the streaming video source (1) comprises a digital video camera (28) for recording a digital video and generating the streaming video.

5. The system according to claim 1, wherein the output (17) comprises an encoder and a transmitter for encoding and transmitting the face-annotated streaming video.

6. The system according to claim 1, wherein the output (17) comprises a display (36) operable connected to receive the face-annotated streaming video from the output terminal and display it to an end user.

7. The system according to claim 1, wherein the streaming video source (1) comprises a receiver and a decoder for receiving and decoding a streaming video.

8. A method for making face-annotation of streaming video, the method comprising the steps of:
receiving streaming video;
performing a real-time face-detection procedure to detect regions holding candidate faces in the streaming video; and
annotating the streaming video by modifying pixel content in the streaming video related to at least one candidate face region.

9. The method of claim 8, further comprising the steps of
providing data identifying one or more faces;
performing a real-time face-recognition procedure to perform a real-time identification of candidate faces in the data; and
including annotation information related to identified candidate faces in the modulation of pixel content in the streaming video.

10. The method of claim 8, wherein the streaming video comprises un-compressed streaming video consisting of image frames, and wherein the face-detection procedure is performed only on selected image frames of the streaming video.
